(19) United States
(12) Patent Application Publication
(10) Pub. No.: US 2012/0317073 A1
(43) Pub. Date: Dec. 13, 2012

(54) Replication Support for Procedures with Arguments of Unsupported Types

(75) Inventors: Ping Zhou, Shanghai (CN); Stephen Shepherd, Lakewood, CO (US)

(73) Assignee: Sybase, Inc., Dublin, CA (US)

(21) Appl. No.: 13/300,003

(22) Filed: Nov. 18, 2011

Related U.S. Application Data
(60) Provisional application No. 61/494,231, filed on Jun. 7, 2011.

(51) Int. Cl. G06F 7/00

(52) U.S. Cl. 707/610; 707/E17.005; 707/E17.044

(57) ABSTRACT

A method, system and computer readable storage medium for replicating procedures with unsupported table data type arguments such as Boolean arguments. The method includes identifying the argument of an unsupported table data type in a procedure to be replicated, mapping the argument to an equivalent supported value, and creating a table containing a column representing the argument as the supported table data type and sending data corresponding to the unsupported table data type argument to a replication server.

### CROSS REFERENCE TO RELATED APPLICATION

This application claims the benefit under 35 U.S.C. §119(e) of U.S. Provisional Patent Application No. 61/494,231, filed on Jun. 7, 2011, which is herein incorporated by reference in its entirety.

### BACKGROUND OF THE INVENTION

1. Field of the Invention

The invention relates generally to databases and more specifically to supporting replication of data procedures that have arguments that are of a type that is not also supported by the existing database table infrastructure.

2. Related Art

Databases have long been used to store the vast amounts of information required by modern companies, educational institutions, governments, and the like. Most modern database systems are de-centralized in that they include several databases that are separated functionally and geographically. One approach for organizing the several databases is to have a primary database and one or more replicate databases that contain mirror copies of the data contained on the primary database. When the content of the primary database is changed, that change must be “replicated” in the replicate databases in order to ensure the integrity of the mirror copies.

Given the large amount of data normally stored on a given database, it is frequently infeasible to replicate the data contained on the primary database by simply copying the entire content of the primary database to the replicate databases. Instead, data replication is accomplished using log-based technology. Through the use of log-based replication, changes to the data in the primary database are captured in a transaction log.

A replication agent can be used to read the primary database's transaction log and propagate the changes to the replicate databases. After replication, the replicate database contains accurate and current copies of the subsets of data found in the primary database. When a table in the primary database is marked for replication, replication agent replicates transactions that manipulate the marked table.

During the replication of a stored procedure, a replication agent can create a so-called “shadow” table with column and data types that match the arguments of the stored procedure. This shadow table can then be used to facilitate the replication of the procedure with its arguments. However, certain data types that are supported as stored procedure arguments (e.g., the Boolean data type) may not be supported as database table column types. Consequently, historically, it has not been possible to replicate procedures with arguments of these “unsupported” table data types. Thus, there exists the need for a way to replicate procedures that have supported argument types that are not supported as database column types.

### BRIEF SUMMARY OF THE INVENTION

Embodiments of the invention include systems, methods and computer-readable mediums for supporting replication of stored procedure arguments and table row and/or column data from a database, the data being extracted by a replication agent and distributed by a replication server. According to embodiments of the present invention, an unsupported table data type argument in a procedure to be replicated is identified. The argument is then mapped to an equivalent value of a supported table data type, and a table is created containing a column that represents the argument where the column is of the supported type. According to aspects of the present invention, procedures having multiple unsupported table data type arguments can also be supported. Data representing the argument of the procedure can then be sent to a replication server as a supported table data type. According to aspects of the present invention, the unsupported table data type can be a Boolean type and the supported table data type can be integer, character, text, or any other appropriate data type.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a block diagram of a database replication system according to an embodiment of the invention.

FIG. 2 is a block diagram of a replication agent according to an embodiment of the invention.

FIG. 3 is a flow chart representing replicating structured data from a primary database to a replicate database according to an embodiment of the present invention.

FIG. 4 depicts a table storing arguments in a function/procedure according to an embodiment of the invention.

FIG. 5 is a flow chart representing a method for replicating procedures with unsupported arguments according to an embodiment of the invention.

FIG. 6 is a flow chart representing a method for replicating procedures with unsupported arguments according to an embodiment of the invention.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

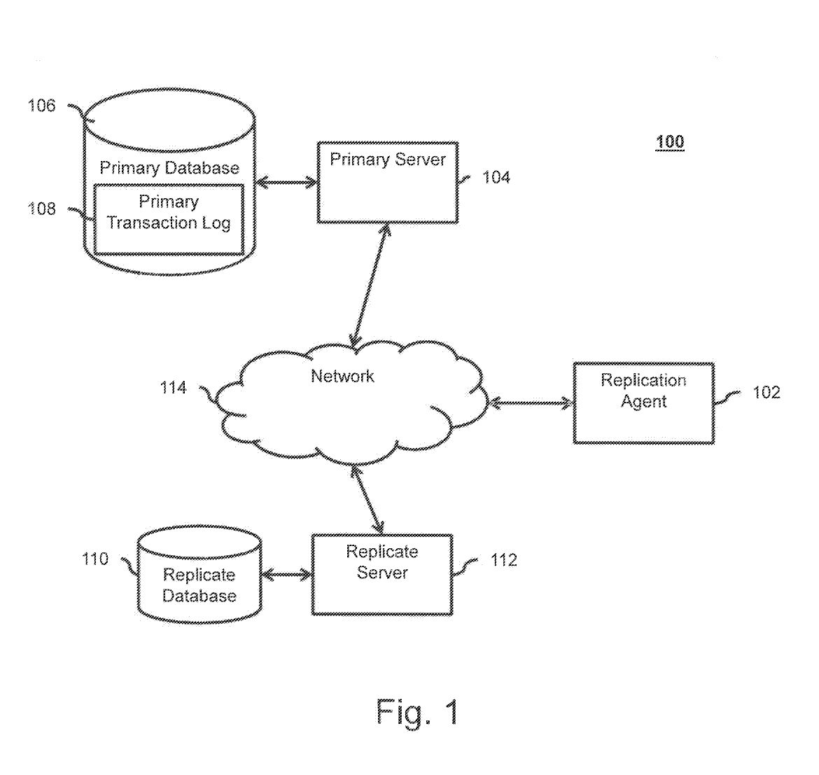

FIG. 1 is a block diagram of an exemplary database replication system 100. Database replication system 100 includes a primary database 106, a replication agent 102, a replication server 112, and one or more replicate databases 110. Database replication system 100 may also include a primary server 104.

Primary database 106 may be any type of a database and may include, but is not limited to, a device having a processor and a memory for executing and storing instructions. Primary database 106 may include software, firmware and hardware or any combination thereof. The software may include one or more applications that create, delete and modify database tables and the data stored in those tables. The hardware may include a processor and memory.

Primary database 106 includes tables and schemas. Typically, the columns of the database tables can have an assigned data type, such as an integer data type, string data type, text data type, or any other data type. Primary database 106 receives transactions from a user or another computing device that may act on the tables and schemas. Those transactions also store, retrieve, modify, and manipulate data stored in primary database 106. The primary database may be connected to network 114 via primary server 104 according to embodiments of the present invention. According to alternative embodiments, the primary database 106 may be connected to network 114 directly.

Database replication system 100 replicates transactions in primary database 106 to replicate databases 110. To do so, the replication agent 102 marks tables in primary database 106 that include transactions that are captured for replication. Once tables are marked for replication, transaction log 108 stores the record of the transactions that manipulate the marked tables.

Primary database transaction log 108 may take any suitable form for storing transactions marked for replication and other changes to the database, such as a text log, a database table, etc. Primary database transaction log 108 may be created and/or maintained by primary database 106, a primary server 104, replication agent 102, or another suitable computing device or process.

Replication agent 102 replicates transactions for tables and schemas marked for replication in primary database 106. To replicate each transaction, replication agent 102 scans transaction log 108 for the relevant transaction. When replication agent 102 identifies each transaction in transaction log 108, it communicates those transactions to replication server 112. Replication agent 102 may be a stand-alone application that is independent of primary database 106, replication server 112 or other components in database replication system 100. Replication agent 102 may also execute on the same or different computing device as primary database 106.

Replication server 112 receives and processes transactions and data received from replication agent 102. Replication server 112 disseminates those transactions to replicate databases 110 or other replication servers 112. When replication server 112 receives transactions from replication agent 102, it delivers those transactions to replicate databases 110, where they are processed. In an embodiment, replication agent 102 provides instructions to replication server 112 for disseminating replicated transactions to replicate databases 110.

Replication server 112 may guarantee the transaction delivery. When transaction delivery is guaranteed, each transaction successfully received from replication agent 102 is guaranteed for delivery to an appropriate replicate database 110.

Replicate database 110 receives transactions from replication server 112 and updates the tables and data with the content included in the transactions. When transactions are successfully processed by replicate database 110, the state of the tables included in replicate database 110 is the same as that of the tables marked for replication on primary database 106.

Database replication system 100 may also include a network 114. The network 114 may be any type of a network or combination of networks such as, but not limited to, a local area network, wide area network or the Internet. Network 114 may be any form of a wired network or a wireless network, or a combination thereof. Network 114 allows primary database 106, replication agent 102, replication server 112 and replication database 110 to communicate among each other, as well as other modules and components.

In another embodiment, replication of data from one database to one or more separate database may involve a replication agent and a replication server. A replication agent may capture changes made to a database. A replication server may distribute the changes captured by the replication agent to the separate databases. The replication agent may convert the changes and transactions captured into a format that the replication server can interpret.

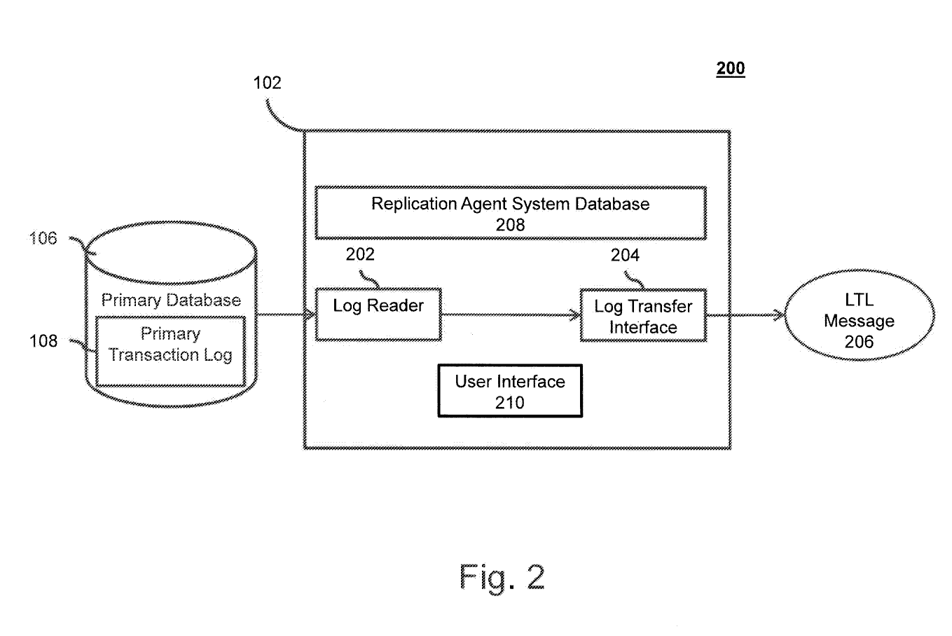

FIG. 2 is a block diagram of an exemplary embodiment 200 of replication agent 102. Elements of the invention may be implemented using, for example, the Sybase Replication Agent product from Sybase, Inc. of Dublin, Calif. However, the invention is not limited to this example implementation. As described herein, replication agent 102 captures transactions from primary database 106 and replicates those transactions to replication server 112. In this embodiment, replication agent 102 further includes a log reader 202, a log transfer interface 204, a replication agent system database (RASD) 208 and a user interface 210. Log reader 202 retrieves transactions from primary database transaction log 108 in primary database 106 and generates a change data set. Log reader 202 passes the change data set to log transfer interface 204.

Log transfer interface 204 receives the change data set from log reader 202. Log transfer interface 204 uses the well-known log transfer language (LTL) to encapsulate the change data set into an LTL message 206. Once LTL message 206 is generated, log transfer interface 204 sends LTL message 206 to primary replication server 112.

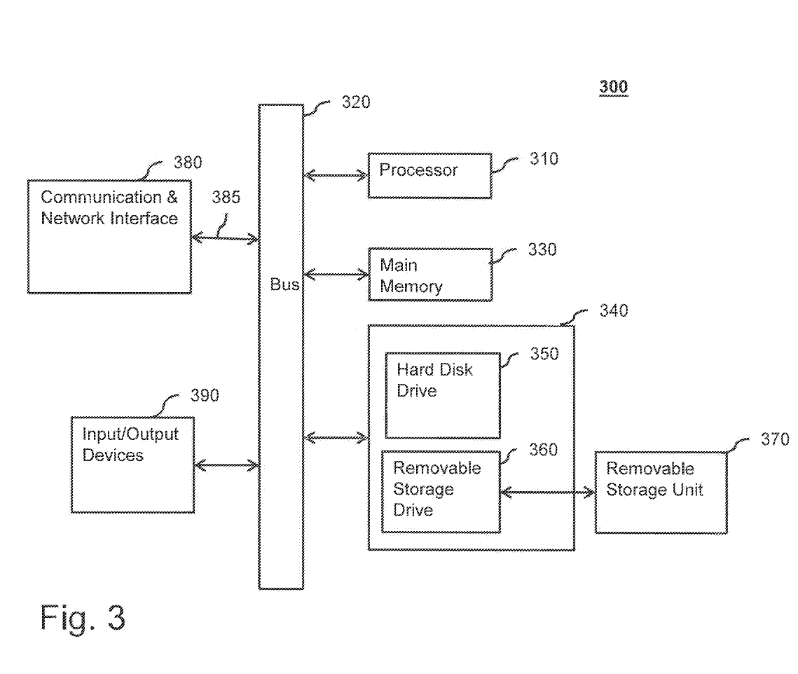

Various aspects of the invention can be implemented by software, firmware, hardware, or a combination thereof. FIG. 3 illustrates an example computer system 300 in which the invention, or portions thereof, can be implemented as computer-readable code. For example, the methods illustrated by flowcharts described herein can be implemented in system 300. Various embodiments of the invention are described in terms of this example computer system 300. After reading this description, it will become apparent to a person skilled in the relevant art how to implement the invention using other computer systems and/or computer architectures.

Computer system 300 includes one or more processors, such as processor 310. Processor 310 can be a special purpose or a general purpose processor. Processor 310 is connected to a communication infrastructure 320 (for example, a bus or network).

Computer system 300 also includes a main memory 330, preferably random access memory (RAM), and may also include a secondary memory 340. Secondary memory 340 may include, for example, a hard disk drive 350, a removable storage drive 360, and/or a memory stick. Removable storage drive 360 may comprise a floppy disk drive, a magnetic tape drive, an optical disk drive, a flash memory, or the like. The removable storage drive 360 reads from and/or writes to a removable storage unit 370 in a well-known manner Removable storage unit 370 may comprise a floppy disk, magnetic tape, optical disk, etc. which is read by and written to by removable storage drive 360. As will be appreciated by persons skilled in the relevant art(s), removable storage unit 370 includes a computer usable storage medium having stored therein computer software and/or data.

In alternative implementations, secondary memory 340 may include other similar means for allowing computer programs or other instructions to be loaded into computer system 300. Such means may include, for example, a removable storage unit 370 and an interface (not shown). Examples of such means may include a program cartridge and cartridge interface (such as that found in video game devices), a removable memory chip (such as an EPROM, or PROM) and associated socket, and other removable storage units 370 and interfaces which allow software and data to be transferred from the removable storage unit 370 to computer system 300.

Computer system 300 may also include a communications and network interface 380. Communications interface 380 allows software and data to be transferred between computer system 300 and external devices. Communications interface 380 may include a modem, a communications port, a PCMCIA slot and card, or the like. Software and data transferred via communications interface 380 are in the form of signals which may be electronic, electromagnetic, optical, or other signals capable of being received by communications interface 380. These signals are provided to communications interface 380 via a communications path 385. Communications path 385 carries signals and may be implemented using wire or cable, fiber optics, a phone line, a cellular phone link, an RF link or other communications channels.

The network interface 380 allows the computer system 300 to communicate over communication networks or mediums such as LANs, WANs the Internet, etc. The net work interface 380 may interface with remote sites or networks via wired or wireless connections.

In this document, the terms “computer program medium” and “computer usable medium” and “computer readable medium” are used to generally refer to media such as removable storage unit 370, removable storage drive 360, and a hard disk installed in hard disk drive 350. Signals carried over communications path 385 can also embody the logic described herein. Computer program medium and computer usable medium can also refer to memories, such as main memory 330 and secondary memory 340, which can be memory semiconductors (e.g. DRAMs, etc.). These computer program products are means for providing software to computer system 300.

Computer programs (also called computer control logic) are stored in main memory 330 and/or secondary memory 340. Computer programs may also be received via communications interface 380. Such computer programs, when executed, enable computer system 300 to implement embodiments of the invention as discussed herein. In particular, the computer programs, when executed, enable processor 310 to implement the processes of the invention, such as the steps in the methods illustrated by flowcharts discussed above. Accordingly, such computer programs represent controllers of the computer system 300. Where the invention is implemented using software, the software may be stored in a computer program product and loaded into computer system 300 using removable storage drive 360, interfaces, hard drive 350 or communications interface 380, for example.

The computer system 300 may also include input/output/display devices 390, such as keyboards, monitors, pointing devices, etc.

The invention is also directed to computer program products comprising software stored on any computer useable medium. Such software, when executed in one or more data processing device(s), causes a data processing device(s) to operate as described herein. Embodiments of the invention employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention can work with software, hardware, and/or operating system implementations other than those described herein. Any software, hardware, and operating system implementations suitable for performing the functions described herein can be used.

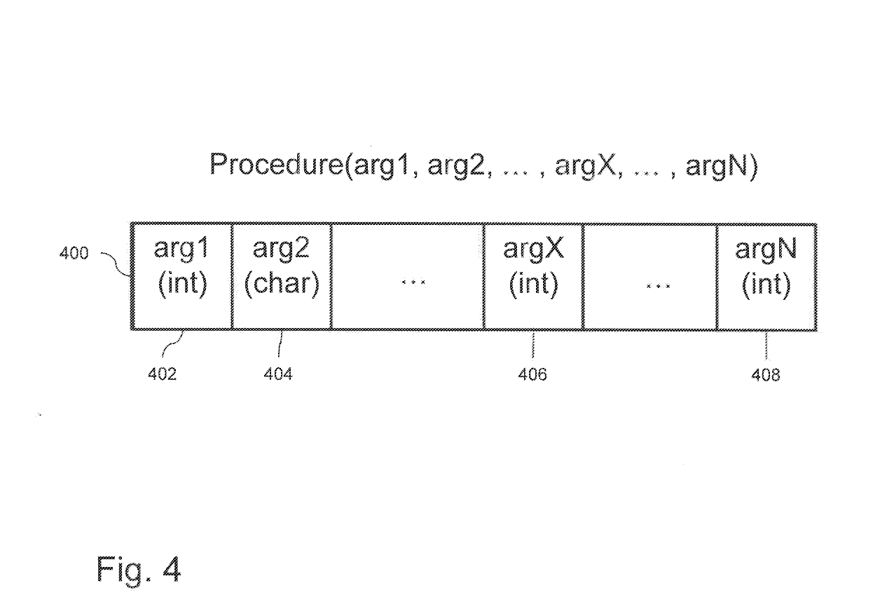

Referring back to FIGS. 1 and 2, the replication agent 102 can, amongst other things, facilitate the replication of stored procedures having arguments of various data types. In order to do so, the replication agent 102 creates a “shadow” table having columns with data types that match the data types of the arguments to the procedure. This concept is depicted in FIG. 4.

A stored procedure may have no arguments or many arguments. For explanatory purposes, FIG. 4 depicts a shadow table 400 for a stored procedure that has N arguments. As noted above, the replication agent 102 creates a column in table 400 matching that argument type. For instance, if a first argument (arg1) is of an integer type, then a column of integer type 402 is created that corresponds to that argument type. Similarly, if a second argument (arg2) is a text type (i.e., char), then the replication agent 102 creates a second column 404 of a text (char) type. A problem arises, however, when one of the arguments (argX) is, for instance, of a Boolean type, and the Boolean type is not a supported type in a database table 400. Accordingly, no column corresponding to the type of argX can be created in shadow table 400. To solve this problem, according to an embodiment, it is necessary to map the unsupported table data type Boolean argument to a supported table data type such as integer and create a column of the supported type 406.

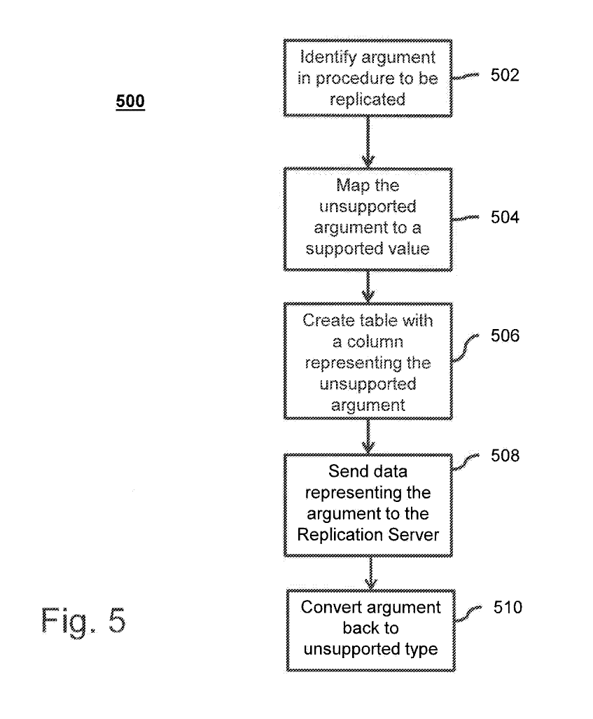

FIG. 5 depicts a process 500 of replicating a procedure having an argument of an unsupported table data type according to embodiments of the present invention. According to the method 500, an argument of an unsupported table data type in a procedure to be replicated is identified at step 502. According to some embodiments, procedures with unsupported table data type arguments are marked as such and can be accordingly identified. According to other embodiments, however, the replication agent 102 can perform a check of procedures to be replicated according to well-known techniques in order to determine whether they have any arguments of the unsupported table data type.

After being identified, the unsupported table data type argument is mapped to a value of a supported table data type at step 504. According to some embodiments, the mapping can be facilitated by capturing the values of unsupported table data type arguments and storing the values as supported table data types in a shadow table. In an embodiment, such a shadow table definition is created by a human operator or by other means prior to or coinciding with the execution of process 500. For instance, a shadow table could be created that captures a Boolean False to the integer 0 and a Boolean True to the integer 1. According to other embodiments, the mapping of step 504 can be achieved by storing the unsupported table data type values as a default supported table data type values (for example, all unsupported table data type values could be stored as character).

Data representing the argument is sent to the replication server at step 508. The process 500 may end at this point. However, according to embodiments of the invention, it is also possible to convert the argument back to the unsupported table data type at step 510. This conversion may take the form of storing the supported table data type values of the arguments as their original unsupported table data type values.

A person of ordinary skill in the art would understand that if a procedure had multiple arguments of an unsupported table data type, that process 500 would be performed for each of the unsupported table data type arguments in the procedure to be replicated.

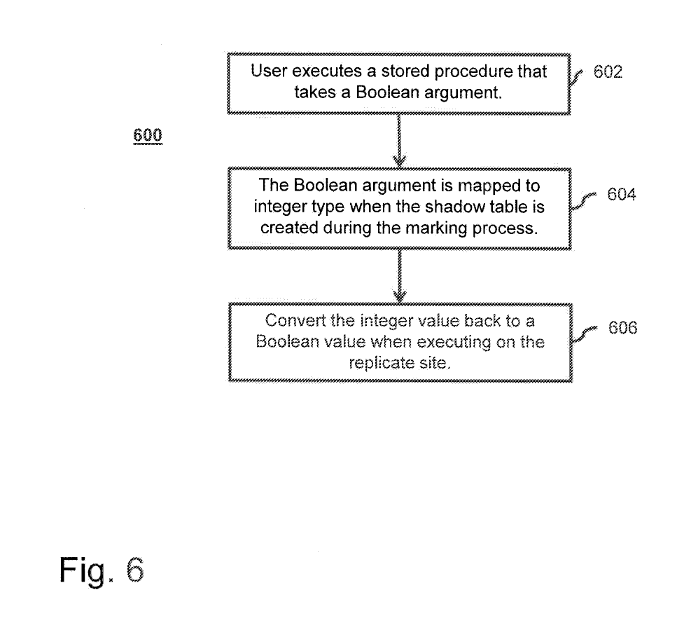

FIG. 6 depicts an example of a process for replicating a procedure with an unsupported table data type argument according to an embodiment of the present invention. As shown in the example of FIG. 6, the unsupported table data type is the Boolean type.

As is shown, the replication process 600 begins upon the execution of a stored procedure that has a Boolean argument at step 602.

In step 604, the Boolean argument must then be mapped to a supported table data type, which is the integer type, in this case. For instance, according to some embodiments, the Boolean value of true could be mapped to the integer value of 1 and the Boolean value of false could be mapped to the integer value of 0. As is shown in FIG. 6, the mapping of the Boolean argument to an integer type variable occurs when the shadow table is created at step 604.

If the replicate database does not support Boolean arguments to stored procedures, then the process can end at step 604. However, if the replicate database 110 does support Boolean arguments to stored procedures, then at step 606 the integer value is converted back to a Boolean value as described herein.

### CONCLUSION

It is to be appreciated that the Detailed Description section, and not the Summary and Abstract sections, is intended to be used to interpret the claims. The Summary and Abstract sections may set forth one or more but not all exemplary embodiments of the invention as contemplated by the inventor(s), and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the invention should not be limited by any of the above-described exemplary embodiments, but should be defined only in accordance with the following claims and their equivalents.

What is claimed is:

1. A method of replicating a procedure from a primary database to a replicate database, comprising:
identifying an argument of a supported argument data type that is also an unsupported table column type in a procedure to be replicated;
mapping said argument to an equivalent value of a supported table column type; and
representing said mapped argument with said supported table column type.

2. The method of claim 1, wherein said procedure has a plurality of arguments of an unsupported table column type and wherein each of the plurality of arguments is mapped to an equivalent value of a supported table column type at said mapping step.

3. The method of claim 1, further including sending data representing said mapped argument to a replication server, wherein said sent data is of a supported table column type.

4. The method of claim 1, wherein the supported data type that is also an unsupported table column type is Boolean.

5. The method of claim 1, wherein the representing said mapped argument further comprises creating a table containing a column with a data type of said supported table column type.

6. A system for replicating a procedure from a primary database to a replicate database, comprising:
a primary database reader configured to identify an argument of a supported data type that is also an unsupported table column type in a procedure to be replicated;
an argument mapper configured to map said argument to an equivalent value of a supported table column type; and
a table generator configured to create a table containing a column representing said mapped argument, wherein said column is of said supported table column type.

7. The system of claim 6, wherein said procedure has a plurality of arguments of an unsupported table column type and wherein each of the plurality of arguments is mapped to an equivalent value of a supported table column type by said argument mapper.

8. The system of claim 6, further including a data transmitter configured to send data representing said mapped argument to a replication server, wherein said sent data is of said supported table column type.

9. The system of claim 6, wherein the supported data type that is also an unsupported table column type is Boolean.

10. The replication agent of claim 6, wherein the supported table column type is an integer type.

11. A computer readable storage medium having instructions stored thereon that, when executed by a processor, cause the processor to perform operations comprising:
identifying an argument of a supported type that is also of an unsupported table column type in a procedure to be replicated;
mapping said argument to an equivalent value of a supported table column type; and
creating a table containing a column representing said mapped argument, wherein said column is of said supported table column type.

12. The computer readable storage medium of claim 11, wherein said procedure has a plurality of arguments of an unsupported table column type and wherein each of the plurality of arguments is mapped to an equivalent value of a supported table column type at said mapping step.

13. The computer readable storage medium of claim 11, further including instructions to perform the operation of sending data representing said mapped argument to a replication server, wherein said sent data is of said supported table column type.

14. The computer readable storage medium of claim 11, wherein the supported data type that is also an unsupported table column type is Boolean.

15. The computer readable storage medium of claim 11, wherein the supported table column type is integer.
